(19) United States
(12) Patent Application Publication
(10) Pub. No.: US 2026/0279320 A1
(43) Pub. Date: Sep. 17, 2026

(54) METHOD FOR IDENTIFYING PLAYING ACTIONS AND PLAYING FRETS OF STRINGED INSTRUMENT

(71) Applicant: Guangzhou Rantion Technology Co., Ltd., Guangzhou, Guangdong (CN)

(72) Inventors: Shaozhi Zhang, Guangzhou, Guangdong (CN); Ruofei Dai, Guangzhou, Guangdong (CN)

(73) Assignee: Guangzhou Rantion Technology Co., Ltd., Guangzhou, Guangdong (CN)

(21) Appl. No.: 18/841,606

(22) PCT Filed: Sep. 8, 2023
(86) PCT No.: PCT/CN2023/117751

§ 371 Date: Aug. 26, 2024

(30) Foreign Application Priority Data
Sep. 21, 2022 (CN) 202211150986.1

(51) Int. Cl. G10H 3/18; G10D 1/08; G10D 3/12; G10H 1/00

(52) U.S. Cl. CPC G10H 3/188; G10D 1/085; G10D 3/12; G10H 1/0008; G10H 2210/031; G10H 2220/461; G10H 2250/235

(57) ABSTRACT

The present disclosure provides a method for identifying a playing action and a playing fret of a stringed instrument, which comprises the following steps: collecting an electrical signal generated by cutting magnetic lines of a strong magnetic magnetic magnet when a string vibrates and outputting an analog signal; filtering, amplifying and biasing the analog signal to output a DC signal; sampling the DC signal and converting the DC signal into a digital signal; operating the digital signal and the outputting a detection result, and sending the detection result to a terminal.

### CROSS-REFERENCE TO RELATED APPLICATIONS

This application is a Section 371 National Stage Application of International Application No. PCT/CN2023/117751, filed on Sep. 8, 2023, entitled “Method for Identifying Playing Actions and Playing Frets of Stringed Instrument”, which claims priority to Chinese Patent Application No. 2022111509861, filed on Sep. 21, 2022, the content of which is incorporated herein by reference in its entirety.

### TECHNICAL FIELD

The present disclosure relates to the technical field of musical instruments, in particular to a method for identifying a playing action and a playing fret of a stringed instrument.

### BACKGROUND

With the progress of science and technology and people's pursuit of artistic life, various techniques to assist in learning musical instruments came into being.

Guitar is a kind of musical instrument popular with young people. In order to facilitate beginners to learn guitar, a new type of guitar has emerged, which can detect guitar playing movements and provide error correction functions. Among them, guitar chord detection generally uses a terminal (such as a mobile phone or a computer) to collect the sound emitted by the guitar through a microphone or the waveform of a piezoelectric pickup through a sound card, then carries out envelope detection on the collected data, converts the extracted harmonic component information into a chromatogram after time-frequency domain conversion, and then compares it with the Pitch Class Profile (PCP for short) of each chord to finally determine which chord is played.

However, since the matching of Pitch Class Profile (PCP), the recognition algorithm is complex, and the storage space and computing power of the terminal are very high, so it can't run on embedded MCU or single chip microcomputer. In addition, the products that are picked up by the microphone for chord recognition are mostly less than 80% in quiet environment, and they are basically unrecognizable if the environment is noisy or the voice is loud.

### SUMMARY

Based on this, there is a need to put forward a method to identify the playing action and playing fret of a stringed instrument, so as to solve the problems of complicated detection method, high cost, low recognition accuracy, high delay and inability to detect the specific fret for identification for the stringed instruments.

The present disclosure relates to a method for identifying a playing action and a playing fret of a stringed instrument. The stringed instrument includes a body, a multi-channel string signal acquisition device and a signal processing device arranged on the body, wherein, the body comprises a nut and a string erected on the nut; the multi-channel string signal acquisition device is arranged below the string and close to the nut, and each channel of the multi-channel string signal acquisition device is provided with a strong magnetic magnetic magnet; the multi-channel string signal acquisition device comprises an analog signal acquisition module, and the signal processing device comprises a signal amplification module, a multi-channel analog-to-digital conversion module, an operation module and a communication module; the method comprises the following steps:
acquiring, by the analog signal acquisition module, an electrical signal generated by cutting the magnetic lines of the strong magnetic magnet when a string vibrates and outputting an analog signal;
outputting a DC signal by the signal amplification module after filtering, amplifying and biasing the analog signal;
sampling the DC signal by the multi-channel analog-to-digital conversion module and converting DC signal into a digital signal;
performing an operation on the digital signal by the operation module, and outputting a detection result; and
sending the detection result to a terminal by the communication module.

Preferably, the multi-channel string signal acquisition device is arranged at a distance of 2 cm-5 cm from the nut, the string is erected on the nut and extends across the multi-channel string signal acquisition device, and a distance between the multi-channel string signal acquisition device and the strings is 1 mm-2 mm.

Preferably, the step of performing an operation on the digital signal by the operation module, and outputting a detection result comprises the following steps:
identifying the playing action on the string;
detecting time domain data;
converting the time domain data into frequency domain data;
calculating a fundamental frequency value by using the time domain data and the frequency domain data; and
establishing a frequency information table of each fret of the stringed instrument according to a standard interval relationship of the stringed instrument, and obtaining the string and the fret corresponding to the fundamental frequency value by a table lookup method.

Preferably, the step of identifying the playing action on the string comprises the following steps:
calculating a number of sampling points SP required for two vibration periods according to an open string vibration Frequency Freq of each string,
continuously compare SP sampling values, finding out a maximum value SVmax and a minimum value SVmin, and calculating a current signal amplitude Samp=SVmax-SVmin;
comparing the current signal amplitude Samp with a previous signal amplitude Samp_last, calculating a difference value Samp_delta=Samp-Samp_last, and determining whether the current signal amplitude is increasing or decreasing;
if the signal amplitude increases, recording a number of times that the signal continuously increases; if the signal amplitude decreases, judging whether a current signal is caused by a user's plucking or other interference factors according to a change of the signal amplitude and marking the signal.

Preferably, the step of judging whether a current signal is caused by a user's plucking or other interference factors according to a change of the signal amplitude and marking the signal comprises the following steps:
establishing a proportion table of magnetic line of force energy leakage;
marking a signal with a slight rebound in an attenuation process as a non-plucked signal;
marking a signal whose number of times of continuous signal increase is greater than or equal to 4 as a resonance signal;
marking a signal whose number of times of continuous signal increase is less than 4 and less than a corresponding amplitude in the proportion table of magnetic line of force energy leakage as a leakage signal; and
marking a signal whose number of times of continuous increase is less than 4 and greater than the corresponding amplitude in the proportion table of magnetic line of force energy leakage as a signal of a new plucking action of the user.

Preferably, the step of detecting time domain data comprises the following steps:
calculating a highest peak threshold high_peak_threshold and a lowest peak threshold low_peak_threshold according to the maximum value SVmax and the minimum value SVmin found by continuously comparing SP sampling values in the step of identifying the playing action on the string; and
detecting peak points in real time to obtain a time difference between the peak points and calculating peak period data.

Preferably, the step of converting the time domain data into frequency domain data comprises the following steps:
grouping the data collected twice into 1024 samples, and then performing fast Fourier transform to convert time domain data into frequency domain data FFT_Data[512].

Preferably, the step of calculating the fundamental frequency value by using the time domain data and the frequency domain data comprises the following steps:
traversing calculation result values of the fast Fourier transform on the collected data, finding out a point FFT_max with a largest amplitude, and calculating a maximum frequency max_amp_freq through a frequency-amplitude average formula;
detecting signal validity;
detecting harmonics; and
calculating a final fundamental frequency final_basic_freq by combining a time domain and a frequency domain.

Preferably, the method for identifying a playing action and a playing fret of a stringed instrument includes the following steps:
comparing the final fundamental frequency final_basic_freq with the frequencies detected by other strings for the signal marked as a leakage signal, and if the frequencies are consistent, confirming that the signal is a leakage signal and discarding the signal;
sending the found information about string number and fret to the terminal for the signal marked as a signal of a new plucking action of the user, and clearing a marked state; and
when it is detected that the fret of a current string number has changed, and no new plucking action of the user is marked, and a difference between a current fret value and a last fret value is less than or equal to 2, indicating that a string sliding action has occurred, and sending the information about the string number, a string sliding direction, the current fret value and the last fret value to the terminal.

The method for identifying a playing action and a playing fret of a stringed instrument provided by the present disclosure includes the following steps: collecting an electrical signal generated by cutting magnetic lines of a strong magnetic magnetic magnet when a string vibrates and outputting an analog signal; filtering, amplifying and biasing the analog signal to output a DC signal; sampling the DC signal and converting the DC signal into a digital signal; operating the digital signal and the outputting a detection result, and sending the detection result to a terminal. Aiming at the problems of low detection accuracy and high delay in the performance of stringed instruments, this paper provides a simple, convenient and low-cost solution, which enables users to obtain a set of performance detection tools at a limited price, and obtain the user's performance data in real time and accurately, and can be widely used in playing error correction, performance recording, music composition, chord recognition, distance teaching and other scenes.

### BRIEF DESCRIPTION OF DRAWINGS

In order to explain the specific embodiment of the present disclosure or the technical solution in the prior art more clearly, the drawings needed in the description of the specific embodiment or the prior art will be briefly introduced below. Obviously, the drawings in the following description are some embodiments of the present disclosure, and other drawings can be obtained according to these drawings without creative work for those skilled in the art.

FIG. 1 is a flowchart of a method for identifying a playing action and a playing fret of a stringed instrument provided by an embodiment;

FIG. 2 is a flow chart of real-time peak point detection of a method for identifying a playing action and a playing fret of a stringed instrument provided by an embodiment;

FIG. 3 is a flowchart of the signal validity detection of the method for identifying a playing action and a playing fret of a stringed instrument provided by an embodiment;

FIG. 4 is a flow chart of harmonic detection of a method for identifying a playing action and a playing fret of a stringed instrument provided by an embodiment;

FIG. 5 is a flowchart for calculating the final fundamental frequency of a method for identifying a playing action and a playing fret of stringed instruments provided by an embodiment;

FIG. 6 is a waveform diagram of the collected signal with the number of sampling points SP of 390 in one vibration period in the method for identifying a playing action and a playing fret of stringed instruments provided by an embodiment;

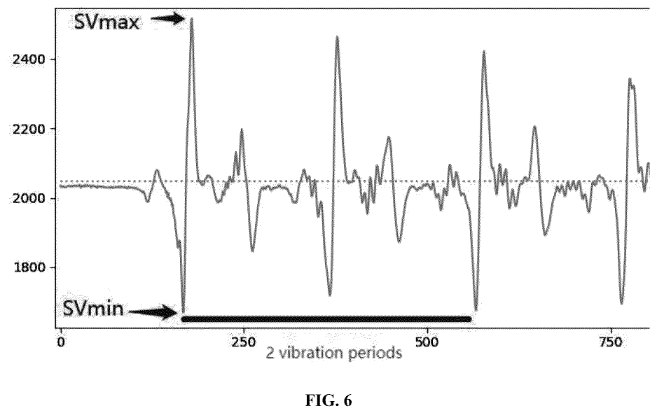

FIG. 7 is a waveform diagram of the vibration frequency of six strings of a stringed instrument at 80 Hz in the method for identifying a playing action and a playing fret of the stringed instrument provided by an embodiment;

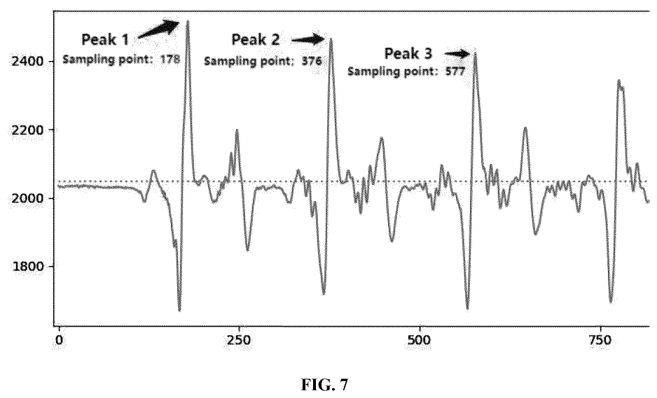

FIG. 8 is a schematic diagram of the highest peak threshold and the lowest peak threshold of the waveform diagram shown in FIG. 7;

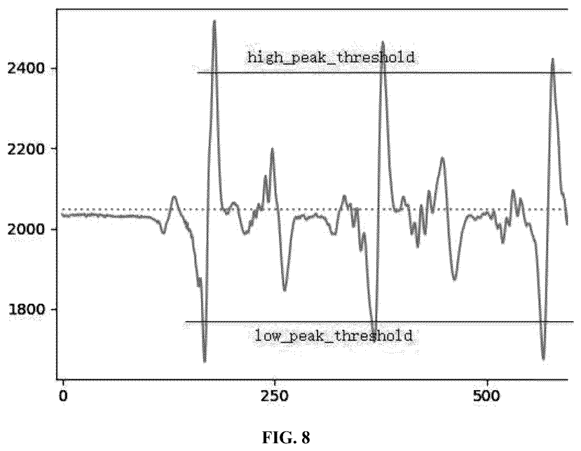

FIG. 9 is a waveform diagram obtained by the method for identifying a playing action and a playing fret of a stringed instrument provided by an embodiment obtained by the processing of real-time peak point detection as shown in FIG. 2;

FIG. 10 is a waveform diagram of 1024 points collected during three-string open string playing in the method for identifying a playing action and a playing fret of a stringed instrument provided by an embodiment;

FIG. 11 is a schematic diagram of the amplitude data corresponding to each frequency point obtained by FFT calculation of the method for identifying a playing action and a playing fret of stringed instruments provided by an embodiment; and

FIG. 12 is a simulation result of signal energy corresponding to each frequency point of three strings in the method for identifying a playing action and a playing fret of a stringed instrument provided by an embodiment.

### DESCRIPTION OF EMBODIMENTS

The technical solution of the present invention will be described clearly and completely with the attached drawings. Obviously, the described embodiment is a part of the embodiment of the present invention, but not the whole embodiment. Based on the embodiments in the present invention, all other embodiments obtained by those skilled in the art without creative labor belong to the scope of protection of the present invention.

As used in this application, the terms “component”, “module” and “system” are intended to refer to computer-related entities, which may be hardware, a combination of hardware and software, software, or software in execution. For example, a component can be, but is not limited to, a process running on a processor, a processor, an object, an executable code, a thread of execution, a program and/or a computer. By way of illustration, both the application running on the server and the server can be components. One or more components may reside in a process and/or thread of execution, and components may be located in one computer and/or distributed between two or more computers.

As used herein, the term “deduction” or “inference” generally refers to the process of deducting or inferring the state of a system, environment and/or user from a set of observations captured via events and/or data. For example, inference can be used to identify a specific context or action, or a probability distribution of states can be generated. Inference can be probabilistic, that is, the probability distribution of states of interest is calculated based on consideration of data and events. Inference may also refer to techniques for synthesizing higher-level events from a set of events and/or data. This kind of inference leads to the construction of new events or actions from a set of observed events and/or stored event data, regardless of whether the events are related in adjacent time, and whether the events and data come from one or several events and data sources.

The present disclosure provides a method for identifying a playing action and a playing fret of a stringed instrument including a body, a multi-channel string signal acquisition device and a signal processing device arranged on the body. The body comprises a nut and a string erected on the nut; the multi-channel string signal acquisition device is arranged below the string and close to the nut. Each channel of the multi-channel string signal acquisition device is provided with a strong magnetic magnetic magnet; the multi-channel string signal acquisition device comprises an analog signal acquisition module, and the signal processing device comprises a signal amplification module, a multi-channel analog-to-digital conversion module, an operation module and a communication module. Take a stringed instrument as an example, the guitar has six metal strings, and the multi-channel string signal acquisition device has six channels. d

The method for identifying a playing action and a playing fret of a stringed instrument includes the following steps:
S100, acquiring, by the analog signal acquisition module, an electrical signal generated by cutting the magnetic lines of the strong magnetic magnet when a string vibrates and outputting an analog signal;
S200, outputting a DC signal by the signal amplification module after filtering, amplifying and biasing the analog signal;
S300, sampling the DC signal by the multi-channel analog-to-digital conversion module and converting DC signal into a digital signal;
S400, performing an operation on the digital signal by the operation module, and outputting a detection result; and
S500, sending the detection result to a terminal by the communication module.

Specifically, in step S100, six independent audio signals, specifically analog signals with signal amplitudes ranging from −40 mv to +40 mv, are finally output by generating changing electric signals by cutting the magnetic lines of force when the metal strings vibrate. In contrast, the common piezoelectric pickup mixes six channels before outputting, and thus it is impossible to accurately judge which string and which product the audio comes from when playing multiple strings at the same time. However, if six signals are output independently, there will be no superposition of sounds, and the algorithm related to frequency detection can be made simpler, and the computational power requirements will be greatly reduced. Especially, according to the lowest vibration frequencies of different strings, the induction coil of the multi-channel string signal acquisition device adopts different winding turns accordingly, which can achieve the maximum induction sensitivity.

In step S200, the signal amplification module filters, amplifies and biases the analog signal output by the analog signal acquisition module, and then outputs a DC signal of 0 to +3.3 v.

In step S300, the multi-channel analog-to-digital conversion module collects DC signals with a sampling frequency of 16 KHz and converts them into digital signals. After collecting 32 ms data (512 sampling points) at a time, the collected data array (SampleData[512]) is output. Because the lowest vibration frequency of the standard guitar theory is 82 Hz, the data collected in 32 ms can contain two complete signal periods, which ensures the accuracy of the subsequent frequency detection related calculation and gives consideration to low delay.

In step S400, the step of performing an operation on the digital signal by the operation module, and outputting a detection result comprises the following steps:
S410, identifying the playing action on the string;
S420, detecting time domain data;
S430, converting the time domain data into frequency domain data;
S440, calculating a fundamental frequency value by using the time domain data and the frequency domain data; and
S450, establishing a frequency information table of each fret of the stringed instrument according to a standard interval relationship of the stringed instrument, and obtaining the string and the fret corresponding to the fundamental frequency value by a table lookup method.

It is known that signals generated by factors such as string resonance, energy leakage of adjacent strings, power supply ripple and so on caused by user's plucking and vibration of guitar cavity can all be collected, and only waveform data generated by user's plucking are valid data, while signals generated by other factors are interference signals and should be filtered out. According to the waveform analysis of each signal, the following conclusions are obtained:

When the user plucks the string, the signal amplitude will increase rapidly in a short time, generally reaching the peak value in 1-8 frequency cycles (the peak value is different according to the plucking strength, and the effective range is 200 mV to 4000 mV), and then the amplitude will slowly attenuate.

Because the guitar vibrates the panel through the vibration of strings, changing the air in the cavity and making sound, as long as the user pulls one string to make sound, other strings will vibrate to a greater or lesser extent, and then the induction coil will collect signals. However, due to the energy transmitted by vibration, the amplitude of the resonant string oscillation increases slowly, reaching the peak in 18 to 40 frequency cycles, and the amplitude of the signal is relatively small, generally between 200 mV and 600 mV.

Because each channel of the multi-channel string signal acquisition module is provided with a strong magnetic magnetic magnet, the magnetic lines of force between adjacent strings intersect, and there will be energy leakage between adjacent strings. For example, when two strings vibrate, there will be a basically fixed proportion of energy leakage to the adjacent induction coils of the first string and the third string, therefore a proportion table of magnetic line energy leakage can be established.

Table 1 is the energy leakage proportion table.

TABLE 1

| | |
|---|---|
| Chord | Leak to |

| number | 1 | 2 | 3 | 4 | 5 | 6 |
|---|---|---|---|---|---|---|
| 1 | — | 0.17 | — | — | — | — |
| 2 | 0.17 | — | 0.40 | — | — | — |
| 3 | — | 0.12 | — | 0.17 | — | — |
| 4 | — | — | 0.12 | — | 0.14 | — |
| 5 | — | — | — | 0.12 | — | 0.14 |
| 6 | — | — | — | — | 0.12 | — |

For example, the energy leaked from the second string to the third string is 0.4. When the signal amplitude of the second string is 1000 mV, the signal amplitude of the third string is 1000 mV*0.4=400 mV. If the signal amplitude detected by the third string is less than 400 mV, it may be the energy signal leaked from the second string.

The signal amplitude of power supply ripple generally changes within 100 mV

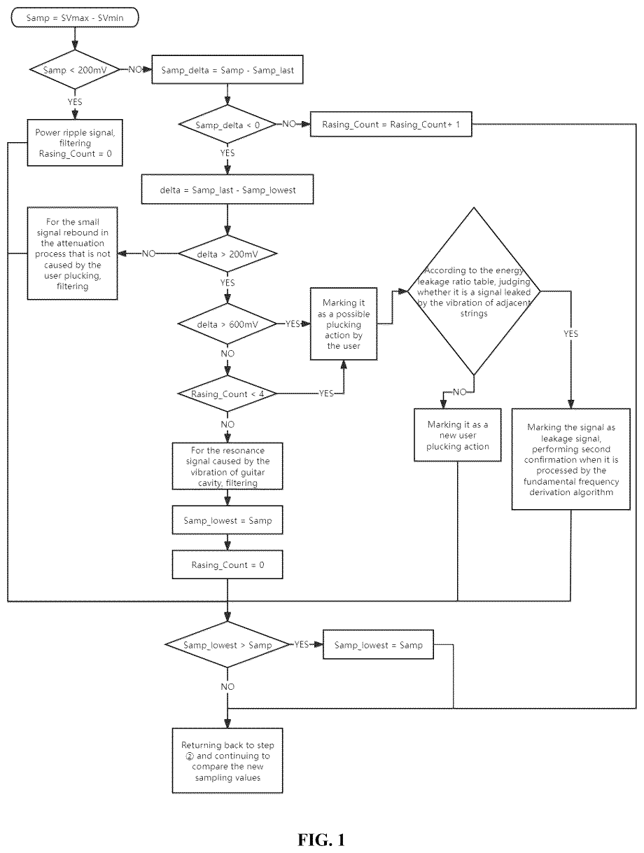

FIG. 1 is a flow chart for identifying a playing action on a string. As shown in FIG. 1, step S410 of identifying a playing action on a string includes the following steps:

S411, according to the open string vibration frequency Freq of each string, the number of sampling points SP=16000/(Freq/2) required for two vibration periods is required.

For example, if the frequency Freq of a 6-string open string is 82 Hz, the number of sampling points in one vibration period is SP=16000/(82/2)=390.

S412, SP sampling values are dcontinuously compared to find the maximum value SVmax and the minimum value SVmin, and the current signal amplitude Samp=SVmax-SVmin is calculated. The number of sampling points SP in one vibration period is the waveform diagram of 390.

S413, the current signal amplitude Samp is compared with the previous signal amplitude Samp_last, the difference value Samp_delta=Samp-Samp_last is calculated, and whether the current signal amplitude is increasing or decreasing is determined. According to the analysis of the collected signals, the frequency of the signal is very unstable during the period of signal amplitude enhancement when playing, but the signal waveform remains basically stable when it enters the attenuation period, and thus it is necessary to perform signal frequency analysis during the attenuation period.

S414, if the signal amplitude increases (Samp_delta>0), the number of times of continuous signal increase is recorded as Rasing_Count=Rasing_Count+1; if the signal amplitude decreases, whether the current signal is caused by the plucking of the string by the user or other interference factors is judged according to the change of the signal amplitude, and the signal is marked.

Further, the step of judging whether the current signal is a signal generated by the plucking of a string by a user or a signal generated by other interference factors and marking the signal includes the following steps:
S415, establishing a proportion table of magnetic line of force energy leakage;
S416, marking a signal with a slight rebound in an attenuation process as a non-plucked signal;
S417, marking a signal whose number of times of continuous signal increase is greater than or equal to 4 as a resonance signal;
S418, marking a signal whose number of times of continuous signal increase is less than 4 and less than a corresponding amplitude in the proportion table of magnetic line of force energy leakage as a leakage signal; and
S419, marking a signal whose number of times of continuous increase is less than 4 and greater than the corresponding amplitude in the proportion table of magnetic line of force energy leakage as a signal of a new plucking action of the user.

Next, time domain data needs to be detected.

According to the waveform analysis of continuously collected signals, the number of sampling points between two peaks is a vibration period, and the corresponding vibration frequency Freq is calculated as follows:

Fre=16000/(current peak sampling point number-previous peak sampling point number)

The following FIG. shows the waveform of vibration frequency at 80 Hz for 6 chords, with 3 peak points marked.

The formula for calculating the frequency is used:

$$16 \; 000 / ( 376 - 178 ) = 80 \text{.8} Hz$$

$$16000 / ( 577 - 376 ) = 7 9.6 Hz$$

The step S420 of detecting time domain data includes the following steps:
S421, the highest peak threshold high_peak_threshold and the lowest peak threshold low_peak_threshold are calculated according to the maximum value SVmax and the minimum value SVmin found by continuously comparing SP sampling values in the step of identifying the playing action on the strings.

Because the signal is constantly changing, this peak point will not have a fixed value. In step S312, the maximum value SVmax and the minimum value SVmin of the signal amplitude in the recent period have been obtained, and the highest peak threshold high_peak_threshold and the lowest peak threshold low_peak_threshold can be calculated by applying the following formula:

$$high\_peak \_threshold = SVmax * 0.7$$

$$low\_peak \_threshold = SVmin * 0.7$$

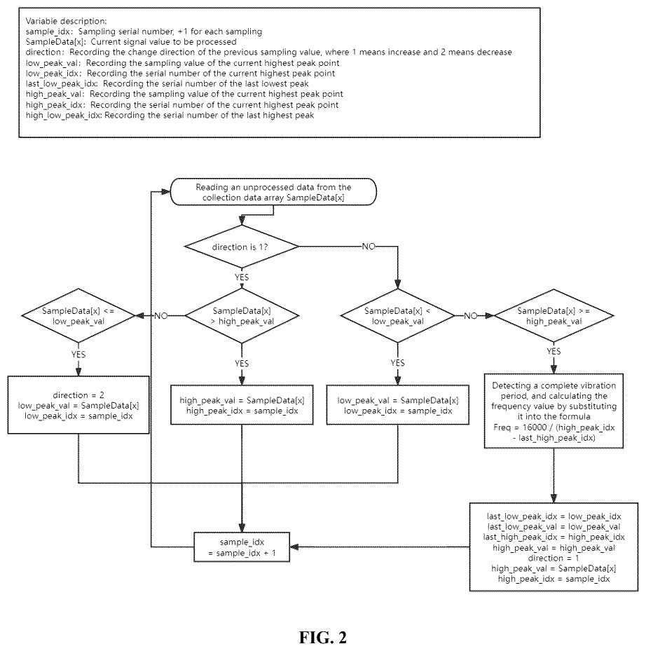

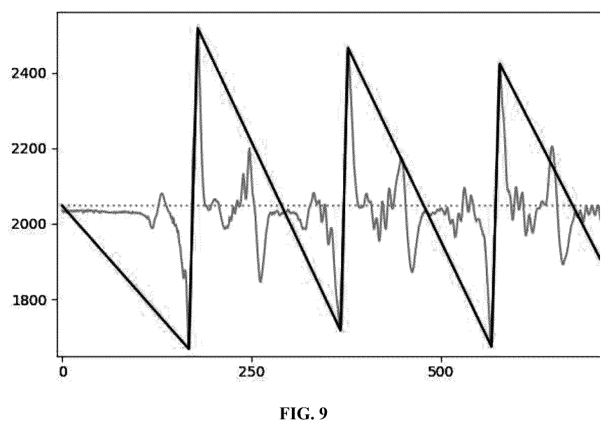

S422, the peak point is detected in real time to obtain the collected data. After the process as shown in FIG. 2, the waveform diagram as shown in FIG. 9 can be obtained.

The step S330 of converting time domain data into frequency domain data includes the following steps:
S431, fast Fourier transform is performed on the collected data, and convert the time domain data into frequency domain data FFT_Data[512].

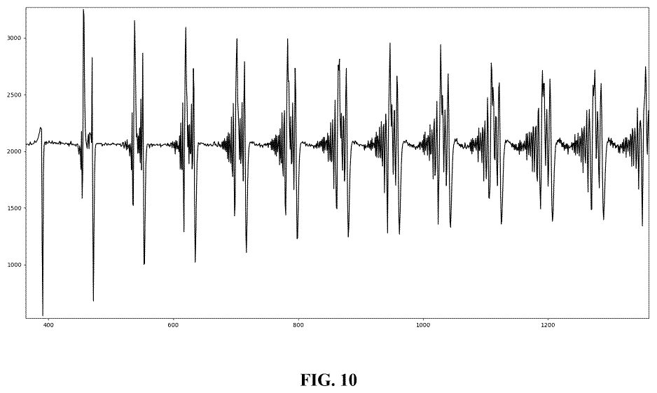

Specifically, the time domain data is converted into frequency domain data FFT_data by performing fast Fourier transform (FFT) on the collected data [512]. Because it is to run on embedded devices, 1024 sampled data are used for FFT, which reduces the need for computing power. Because the multi-channel ADC conversion module only collects 512 data at a time, it is necessary to pack the previous group of data and the current data into a package of 1024 data. FIG. 10 is the waveform diagram of 1024 points collected when playing 3-string open string.

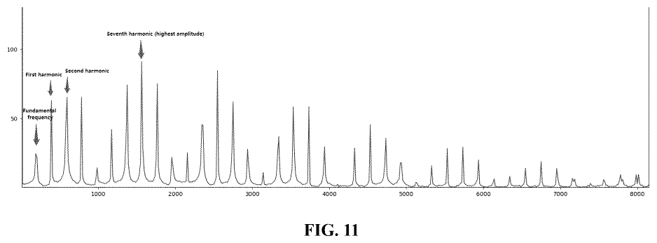

As shown in FIG. 11, after FFT calculation, the amplitude data diagram corresponding to each frequency point is obtained.

Through the analysis of the above figure, the sound emitted by each string is composed of the main frequency and its harmonics. Take an open string with three strings as an example: its fundamental frequency is 196 Hz, the first harmonic is 196*2=392 Hz, the second harmonic is 196*3=588 Hz, and so on.

According to the resolution formula of Fast Fourier Transform (FFT):

$$\frac{{f}_{1}}{{N}_{FFT}} ,$$

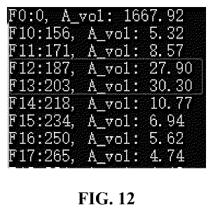

at present, with the sampling frequency of 16 KHz, the resolution calculated by 1024 sampling points is 16,000 Hz/1024=15.625 Hz. That is, the accurate frequency value of the input signal can only be obtained by FFT calculation. By analyzing the characteristics of the FFT results, it can be known that if the frequency of the detected signal is not multiple of the resolution, the energy of this signal will be distributed to two frequency points close to it in proportion, as shown in FIG. 12, taking an open string with three strings (196 Hz) as an example, 196/15.625=12.544, therefore this frequency just falls between the 12th and 13th points of the FFT results.

Therefore, the following frequency-amplitude average formula can be derived:

$$Freq = FFT\_left * 15.625 + ( FFT\_Data [ FFT\_left ] / ( FFT\_Data [ FFT\_left ] + FFT\_Data [ FFT\_right ] ) ) * 15.625 .$$

The frequency point can be accurately calculated according to the result value of FFT, where FFT_left is the point where the FFT is slightly smaller than the input signal frequency, FFT_Data[FFT_left] is the signal amplitude of the point where the FFT is slightly smaller than the input signal frequency, and FFT_Data[FFT_right] is the signal amplitude of the point where the FFT is slightly larger than the input signal frequency.

The data is substituted in the above figure into the formula to calculate:
12*15.625+(30.3/(27.9+30.3))*15.625=195.6 Hz, which is about equal to the original signal of 196 Hz.

If the signal waveform is clean when playing a certain string alone, the prepared fundamental frequency value can be obtained in most cases through the fundamental frequency detection algorithm based on time domain or the time-frequency conversion algorithm. However, once multiple strings are played at the same time or connected, due to the superposition of factors such as string resonance caused by the vibration of the guitar cavity, energy leakage of adjacent strings, ripple of the power supply, loose pressing of the strings, and envelope sticking caused by the continuous playing of the same string, the time domain signal period is unclear, FFT fundamental frequency is lost, FFT harmonic is lost, etc., which makes it difficult to identify the input frequency with high accuracy by only one algorithm, so it is necessary to calculate the correct fundamental frequency value by using both time domain and frequency domain.

The step S440 of calculating the fundamental frequency value by using time domain data and frequency domain data includes the following steps:
S441, traversing calculation result values of the fast Fourier transform on the collected data, finding out a point FFT_max with a largest amplitude, and calculating a maximum frequency max_amp_freq through a frequency-amplitude average formula;
S442, detecting signal validity;
S443, detecting harmonics; and
S444, calculating a final fundamental frequency final_basic_freq by combining a time domain and a frequency domain.

Specifically, in step S441, it is known that the point with the largest amplitude after FFT processing must be the fundamental frequency or the n^{th} harmonic of the fundamental frequency, therefore the calculation result value of FFT is first traversed to find the point with the largest amplitude FFT_max, and the frequency max_amp_freq is calculated through the frequency amplitude average formula.

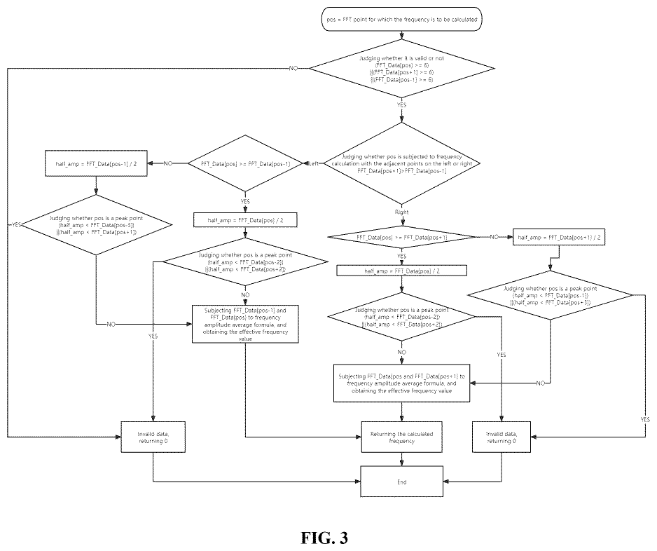

Because the data of FFT_Data[ ] contains many frequencies introduced by interference factors, to get the actual frequency of a certain point of FFT_Data[ ], it is necessary to do signal validity detection first, and calculate the correct frequency according to the amplitude relationship between a certain point and its neighboring points, as shown in FIG. 3.

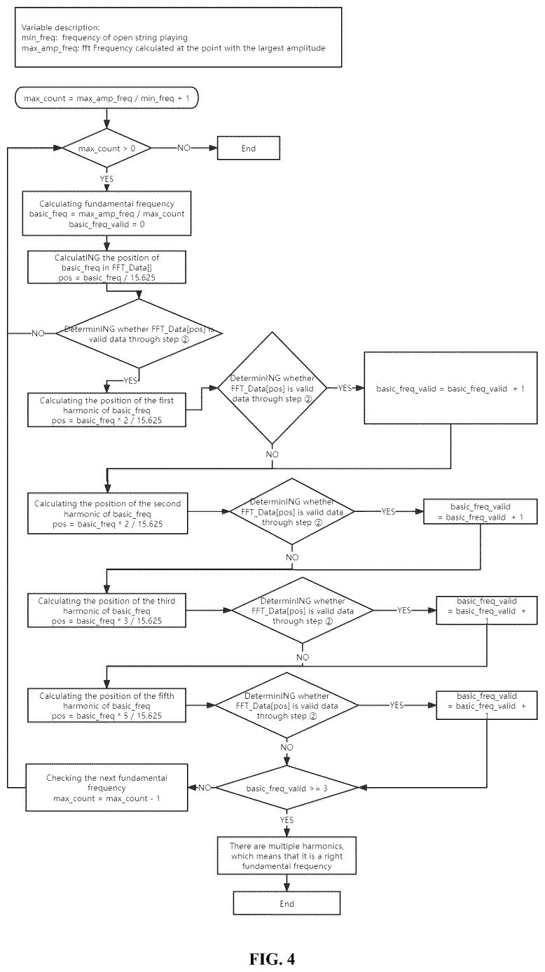

Because the harmonics are multiples of the fundamental frequency, the harmonics is divided by a certain value to get the fundamental frequency, and then whether this fundamental frequency has 2-, 3-, 5- and 7-frequency-doubled harmonics is checked, as shown in FIG. 4.

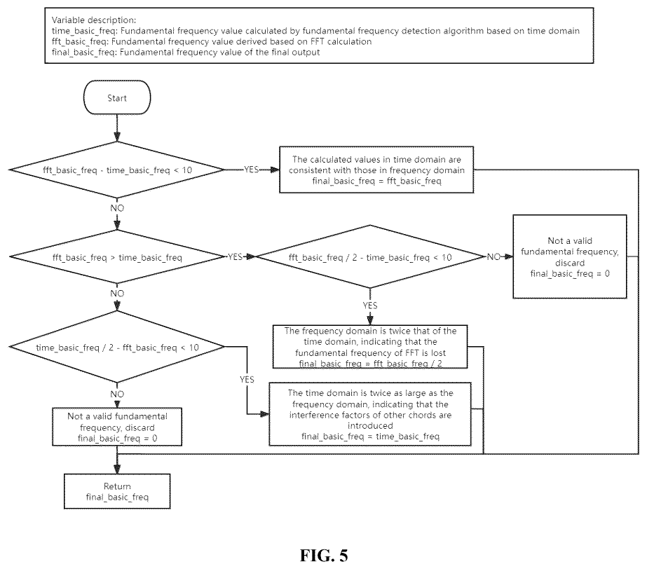

Finally, the final fundamental frequency final_basic_freq is calculated by combining time domain and frequency domain, as shown in FIG. 5.

According to the standard interval relationship of the guitar, the frequency information of each fret on the guitar can be obtained. Table 2 is the frequency comparison table of guitar fret.

| | Open string | 1 Fret | 2 Fret | 3 Fret | 4 Fret | 5 Fret | 6 Fret | 7 Fret | 8 Fret | 9 Fret | 10 Fret |
|---|---|---|---|---|---|---|---|---|---|---|---|
| 1 String | 329.63 | 349.23 | 369.99 | 392 | 415.3 | 440 | 466.16 | 493.88 | 523.25 | 554.37 | 587.33 |
| 2 String | 246.94 | 261.63 | 277.18 | 293.66 | 311.13 | 329.63 | 349.23 | 369.99 | 392 | 415.29 | 440 |
| 3 String | 196 | 207.65 | 220 | 233.08 | 246.94 | 261.63 | 277.18 | 293.66 | 311.13 | 329.63 | 349.23 |
| 4 String | 146.83 | 155.56 | 164.81 | 174.61 | 185 | 196 | 207.65 | 220 | 233.08 | 246.94 | 261.63 |
| 5 String | 110 | 116.54 | 123.47 | 130.81 | 138.59 | 146.83 | 155.56 | 164.81 | 174.61 | 185 | 196 |
| 6 String | 82.407 | 87.307 | 92.499 | 97.999 | 103.83 | 110 | 116.54 | 123.47 | 130.81 | 138.59 | 146.83 |

| | 11 Fret | 12 Fret | 13 Fret | 14 Fret | 15 Fret | 16 Fret | 17 Fret | 18 Fret | 19 Fret | 20 Fret |
|---|---|---|---|---|---|---|---|---|---|---|
| 1 String | 622.25 | 659.26 | 698.46 | 739.99 | 783.99 | 830.61 | 880 | 932.33 | 987.77 | 1046.5 |
| 2 String | 466.16 | 493.88 | 523.25 | 554.37 | 587.33 | 622.25 | 659.26 | 698.46 | 739.99 | 783.99 |
| 3 String | 369.99 | 392 | 415.3 | 440 | 466.160004 | 493.88 | 523.25 | 554.37 | 587.33 | 622.25 |
| 4 String | 277.18 | 293.66 | 311.13 | 329.63 | 349.23 | 369.99 | 392 | 415.3 | 440 | 466.16 |
| 5 String | 207.65 | 220 | 233.08 | 246.94 | 261.63 | 277.18 | 293.66 | 311.13 | 329.63 | 349.23 |
| 6 String | 155.56 | 164.81 | 174.61 | 185 | 196 | 207.65 | 220 | 233.08 | 246.94 | 261.63 |

In this embodiment, the method for identifying a playing action and a playing fret of the stringed instrument further includes the following steps:
comparing the final fundamental frequency final_basic_freq with the frequencies detected by other strings for the signal marked as a leakage signal, and if the frequencies are consistent, confirming that the signal is a leakage signal and discarding the signal;
sending the found information about string number and fret to the terminal for the signal marked as a signal of a new plucking action of the user, and clearing a marked state; and
when it is detected that the fret of a current string number has changed, and no new plucking action of the user is marked, and a difference between a current fret value and a last fret value is less than or equal to 2, indicating that a string sliding action has occurred, and sending the information about the string number, a string sliding direction, the current fret value and the last fret value to the terminal.

When all the algorithms are executed, the fundamental frequency information corresponding to the currently collected signal, the string number and fret information of playing and the information of string sliding action can be sent to the terminal in time, and the terminal can perform lighting interaction, performance recording, chord recognition and other processing according to these original data, thus increasing the interestingness.

In addition, the terminal can adjust the relevant thresholds of the fundamental frequency detection algorithm based on time domain and the fundamental frequency derivation algorithm according to the installation position of the multi-channel string signal acquisition device, so as to improve or reduce the detection sensitivity, and adjust the open string frequency to achieve the purpose of tone modulation.

The method for identifying a playing action and a playing fret of a stringed instrument provided by the present disclosure includes the following steps: collecting an electrical signal generated by cutting magnetic lines of a strong magnetic magnetic magnet when a string vibrates and outputting an analog signal; filtering, amplifying and biasing the analog signal to output a DC signal; sampling the DC signal and converting the DC signal into a digital signal; operating the digital signal and the outputting a detection result, and sending the detection result to a terminal. Aiming at the problems of low detection accuracy and high delay in the performance of stringed instruments, this paper provides a simple, convenient and low-cost solution, which enables users to obtain a set of performance detection tools at a limited price, and obtain the user's performance data in real time and accurately, and can be widely used in playing error correction, performance recording, music composition, chord recognition, distance teaching and other scenes.

The above embodiments are only used to illustrate the technical solution of the present disclosure, but not to limit it; Although the present disclosure has been described in detail with reference to the foregoing embodiments, it should be understood by those skilled in the art that the technical solution described in the foregoing embodiments can still be modified, or some or all of its technical features can be replaced by equivalents; However, these modifications or substitutions do not make the essence of the corresponding technical solutions deviate from the scope of the technical solutions of various embodiments of the present disclosure.

What is claimed is:

1. A method for identifying a playing action and a playing fret of a stringed instrument comprising a body, a multi-channel string signal acquisition device and a signal processing device arranged on the body, wherein, the body comprises a nut and a string erected on the nut; the multi-channel string signal acquisition device is arranged below the string and close to the nut, and each channel of the multi-channel string signal acquisition device is provided with a strong magnetic magnetic magnet; the multi-channel string signal acquisition device comprises an analog signal acquisition module, and the signal processing device comprises a signal amplification module, a multi-channel analog-to-digital conversion module, an operation module and a communication module; the method comprises the following steps:
acquiring, by the analog signal acquisition module, an electrical signal generated by cutting the magnetic lines of the strong magnetic magnet when a string vibrates and outputting an analog signal;
outputting a DC signal by the signal amplification module after filtering, amplifying and biasing the analog signal;
sampling the DC signal by the multi-channel analog-to-digital conversion module and converting DC signal into a digital signal;
performing an operation on the digital signal by the operation module, and outputting a detection result; and
sending the detection result to a terminal by the communication module.

2. The method for identifying a playing action and a playing fret of a stringed instrument according to claim 1, wherein the multi-channel string signal acquisition device is arranged at a distance of 2 cm-5 cm from the nut, the string is erected on the nut and extends across the multi-channel string signal acquisition device, and a distance between the multi-channel string signal acquisition device and the strings is 1 mm-2 mm.

3. The method for identifying a playing action and a playing fret of a stringed instrument according to claim 2, wherein the step of performing an operation on the digital signal by the operation module, and outputting a detection result comprises the following steps:
identifying the playing action on the string;
detecting time domain data;
converting the time domain data into frequency domain data;
calculating a fundamental frequency value by using the time domain data and the frequency domain data; and
establishing a frequency information table of each fret of the stringed instrument according to a standard interval relationship of the stringed instrument, and obtaining the string and the fret corresponding to the fundamental frequency value by a table lookup method.

4. The method for identifying a playing action and a playing fret of a stringed instrument according to claim 3, wherein the step of identifying the playing action on the string comprises the following steps:
calculating a number of sampling points SP required for two vibration periods according to an open string vibration Frequency Freq of each string,
continuously compare SP sampling values, finding out a maximum value SVmax and a minimum value SVmin, and calculating a current signal amplitude Samp=SVmax−SVmin;
comparing the current signal amplitude Samp with a previous signal amplitude Samp_last, calculating a difference value Samp_delta=Samp−Samp_last, and determining whether the current signal amplitude is increasing or decreasing;
if the signal amplitude increases, recording a number of times that the signal continuously increases; if the signal amplitude decreases, judging whether a current signal is caused by a user's plucking or other interference factors according to a change of the signal amplitude and marking the signal.

5. The method for identifying a playing action and a playing fret of a stringed instrument according to claim 4, wherein the step of judging whether a current signal is caused by a user's plucking or other interference factors according to a change of the signal amplitude and marking the signal comprises the following steps:
establishing a proportion table of magnetic line of force energy leakage;
marking a signal with a slight rebound in an attenuation process as a non-plucked signal;
marking a signal whose number of times of continuous signal increase is greater than or equal to 4 as a resonance signal;
marking a signal whose number of times of continuous signal increase is less than 4 and less than a corresponding amplitude in the proportion table of magnetic line of force energy leakage as a leakage signal; and
marking a signal whose number of times of continuous increase is less than 4 and greater than the corresponding amplitude in the proportion table of magnetic line of force energy leakage as a signal of a new plucking action of the user.

6. The method for identifying a playing action and a playing fret of a stringed instrument according to claim 5, wherein the step of detecting time domain data comprises the following steps:
calculating a highest peak threshold high_peak_threshold and a lowest peak threshold low_peak_threshold according to the maximum value SVmax and the minimum value SVmin found by continuously comparing SP sampling values in the step of identifying the playing action on the string; and
detecting peak points in real time to obtain a time difference between the peak points and calculating peak period data.

7. The method for identifying a playing action and a playing fret of a stringed instrument according to claim 6, wherein the step of converting the time domain data into frequency domain data comprises the following steps:
grouping the data collected twice into 1024 samples, and then performing fast Fourier transform to convert time domain data into frequency domain data FFT_Data[512].

8. The method for identifying a playing action and a playing fret of a stringed instrument according to claim 7, wherein the step of calculating the fundamental frequency value by using the time domain data and the frequency domain data comprises the following steps:
traversing calculation result values of the fast Fourier transform on the collected data, finding out a point FFT_max with a largest amplitude, and calculating a maximum frequency max_amp_freq through a frequency-amplitude average formula;
detecting signal validity;
detecting harmonics; and
calculating a final fundamental frequency final_basic_freq by combining a time domain and a frequency domain.

9. The method for identifying a playing action and a playing fret of a stringed instrument according to claim 8, further comprising the following steps:
comparing the final fundamental frequency final_basic_freq with the frequencies detected by other strings for the signal marked as a leakage signal, and if the frequencies are consistent, confirming that the signal is a leakage signal and discarding the signal;
sending the found information about string number and fret to the terminal for the signal marked as a signal of a new plucking action of the user, and clearing a marked state; and
when it is detected that the fret of a current string number has changed, and no new plucking action of the user is marked, and a difference between a current fret value and a last fret value is less than or equal to 2, indicating that a string sliding action has occurred, and sending the information about the string number, a string sliding direction, the current fret value and the last fret value to the terminal.
